(19) United States
(12) Patent Application Publication
(10) Pub. No.: US 2014/0008432 A1
(43) Pub. Date: Jan. 9, 2014

(54) METHOD FOR HUB AND SPOKES PIN VERIFICATION FOR CREDIT CARDS WITH CARD INFORMATION STORED IN A MAGNETIC STRIPE

(71) Applicants: Jacob de Geer, Stockholm (SE); Magnus Nilsson, Djursholm (SE)

(72) Inventors: Jacob de Geer, Stockholm (SE); Magnus Nilsson, Djursholm (SE)

(73) Assignee: IZETTLE HARDWARE AB, Stockholm (SE)

(21) Appl. No.: 13/544,301

(22) Filed: Jul. 9, 2012

(51) Int. Cl. G06Q 20/34

(52) U.S. Cl. 235/379

(57) ABSTRACT

A method of conducting an electronic card payment between a merchant, having a merchant's device, and a cardholder, having a payment card and a cardholder's device. The method include reading payment card information associated with the payment card using the card reader in the merchant's device, entering purchase information in the merchant's device and transmitting the purchase information and the payment card information to a payment server, entering a personal identification number (PIN) in the cardholder's device, and submitting the PIN to the payment server, and transmitting the purchase information and an updated payment card information comprising at least the PIN to a bank server conducting the card payment.

### TECHNICAL FIELD

The invention relates in general to the field of secure electronic credit transactions, and more particularly, to a method and a system for secure credit card payment using a credit card with a magnetic stripe.

### BACKGROUND

Every day an incredible number of credit card payments are made around the world, and the number of payments are steadily increasing.

EMV is the leading payment system specification for credit cards on the market and was jointly developed by the companies Europay International, Mastercard International, and Visa International, hence the abbreviation EMV. To be able to develop a credit card payment system that is capable of using standard EMV approved credit cards, it is essential that the payment system fulfills the EMV specification.

The majority of credit card payments are still made in stores using bulky and stationary EMV approved point-of-sale (POS) terminals. However, in the last couple of years the interest, both from the public and from companies, of being able to make payments with portable hand-held devices such as mobile phones have grown rapidly. However, the mobile phone alone is not considered to be a secure device and does not fulfill the requirements for conducting a secure EMV approved payment.

It has previously been shown that a credit card payment can be made secure and EMV approved using a specialized secure card reader device attachable to a mobile phone in the manner presented in the

International patent application with the application number PCT/EP2010/066186 by the iZettle company. However, the method presented in PCT/EP2010/066186 relies on that the cardholder has a payment card with an integrated EMV approved chip which can be read by the secure card reader device, which today is not always the case, for instance when the payment card only has a magnetic stripe or when only a unsecure card reader device is available.

Thus, finding a way to be able to make secure and EMV approved credit card payments using a payment card with a magnetic strip and an ordinary unsecure mobile phone with an unsecure card reader device is therefore highly sought after.

### SUMMARY OF THE INVENTION

With the above description in mind, then, an aspect of the present invention is to provide a way to make secure and EMV approved credit card payments using a payment card with a magnetic strip and an ordinary unsecure mobile phone with an unsecure card reader device which seek to mitigate, alleviate, or eliminate one or more of the above-identified deficiencies in the art and disadvantages singly or in any combination with a sustained level of payment security.

A first aspect of the present invention relates to a method of conducting an electronic card payment between a merchant, having a merchant's device with a card reader, and a cardholder, having a payment card and a cardholder's device, characterized in that it comprises reading payment card information associated with said payment card using said card reader in said merchant's device, entering purchase information in the merchant's device and transmitting said purchase information and said payment card information to a payment server, entering a personal identification number (PIN) in said cardholder's device, and submitting said PIN to said payment server, and transmitting said purchase information and an updated payment card information comprising at least said PIN to a bank server (106) conducting said card payment.

The method may further comprise that in said payment sever retrieving, from previously stored payment card information, at least one contact information associated with said received payment card information, and transmitting a request for PIN message to said cardholder's device (103), using said contact information.

The invention further relates to a method wherein said request for PIN message contains a web address of a secure web page on said payment server and wherein the step of submitting the PIN comprises submitting said PIN via said web page.

The invention further relates to a method wherein the contact information may be at least one phone number or one email address.

The method may further comprise transmitting said at least one contact information associated with said payment card to said merchant's device, and selecting in said merchant's device a contact information to use for communication with said cardholder's device and transmitting information about said selection to said payment server, and wherein said request for PIN message is transmitted to said cardholder's device, using said selected contact information.

The method may further comprise transmitting a receipt message and a signature request from said payment server to said merchant's device and signing said receipt message and transmitting said signed receipt message to said payment server.

The method may further comprise determining, in the merchant's device, the geographical coordinates of the merchant's device, and transmitting it to said payment server determining, in the cardholder's device, the geographical coordinates of the cardholder's device, and submitting it to said payment server in the payment server comparing the geographical coordinates of the merchant's device and the cardholder's device, and if said geographical coordinates are separated more than a specified distance from each other an rejection message is transmitted from said payment server to said merchant's device and/or to the cardholder's device.

The method may further comprise the step of starting a time-limited payment session in the payment server when said purchase information and payment card information is received from said merchant's device.

A second aspect of the present invention relates to a system for conducting an electronic card payment between a merchant and a cardholder, the system comprising a merchant's device, a cardholder's device and a payment server characterized in that said merchant's device, cardholder's device and payment server, are adapted to perform the steps described in the first aspect of the present invention related to a method for conducting an electronic card payment between a merchant and a cardholder as described above.

### BRIEF DESCRIPTION OF THE DRAWINGS

Further objects, features, and advantages of the present invention will appear from the following detailed description of some embodiments of the invention, wherein some embodiments of the invention will be described in more detail with reference to the accompanying drawings, in which:

FIG. 1 shows a block diagram of a system for conducting card payments using an ordinary mobile device and a card reader device, according to an embodiment of the present invention; and

FIG. 2 shows a flow chart describing the steps in a method for conducting a credit card payment, according to the embodiment of the present invention.

### DETAILED DESCRIPTION

Embodiments of the present invention, and variants thereof, will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference signs refer to like elements throughout.

Embodiments of the present invention will be exemplified using a mobile communication device such as a mobile phone. However, it should be appreciated that the invention is as such equally applicable to electronic devices in general which have wired- and/or wireless communication capabilities. Examples of such devices may for instance be any type of mobile phone, laptop (such as standard, ultra portables, netbooks, and micro-laptops), handheld computer, portable digital assistant, tablet computer, gaming device, accessory to mobile phones, etc. However, for the sake of clarity and simplicity, the embodiments outlined in this specification are exemplified with, and related to, mobile phones only.

Embodiments of the present invention will be exemplified using a credit card. However, it should be appreciated that the invention is as such equally applicable to any type of credit card having a magnetic strip conforming to the ISO/IEC 7811 numbering standard. Examples of such credit cards (hereinafter referred to as payment cards) may for instance be any type of debit card, charge card, fleet card, store-value card, or gift card.

Today, credit card payments are commonly authorized by entering a personal identification number (PIN) that is either verified on-line with the issuing bank, also known as an on-line verification, or against the information stored in a secure microchip on the payment card, also known as an off-line verification. A payment card payment may also be authorized by the cardholder's signature. In that case the magnetic stripe of the credit card is read by a secure payment device, the cardholder notifies the merchant that he or she does not have a PIN code for the payment card after which the merchant hands over a paper slip to the cardholder and requesting the cardholder to sign it with his or hers signature.

All above described methods for authorizing a payment card payment are EMV-approved methods for carrying out a payment card payment where the sensitive card information is either stored in a secure chip or in a magnetic stripe read by a secure card reader attached or integrated into a secure payment device. In contrast the present invention, which will be described in detail below, deals with how to make a secure and EMV-approved payment card payment with a payment card with a magnetic strip using an ordinary unsecure payment device with an unsecure card reader.

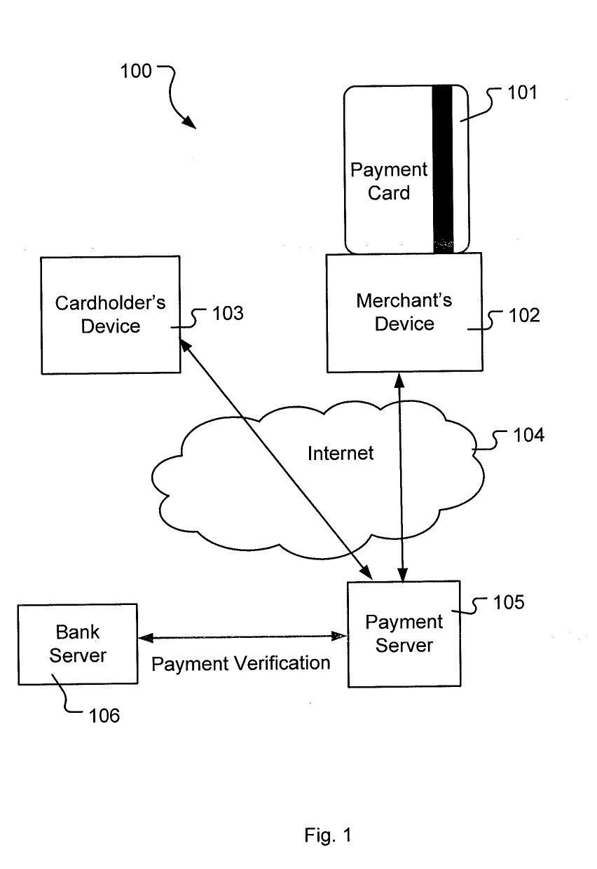

The present invention and embodiments and variants thereof will now be described in detail. However, to gain a better understanding of how the present invention works it will be described using a typical use-case. The use-case will describe a method and a payment system for conducting secure electronic card payments using ordinary mobile devices and without the need for any type of specialized secure card reader for reading payment cards with a magnetic strip. FIG. 1 shows a block diagram of such a secure electronic payment system 100 comprising a payment card with a magnetic stripe 101, a merchant's device 102 which may be an ordinary mobile phone with an integrated or add-on unsecure card reader, a cardholders' device 103 which also may be an ordinary mobile phone, a payment server 105 handling the payment session and a bank server 106.

The cardholder will, when paying for the item or service he or she wishes to purchase, present his or hers payment card 101 with a magnetic strip to the merchant.

The merchant will initiate a payment application in the merchant's device 102,201. The merchant's device 102 could be any type of electronic device having the capability of running a payment application, having a user-interface for presenting and inputting information, a (unsecure) card reader device either integrated, attached or in communication with it, and means for communicating either by wire or wireless with a payment server 105 over a communication network 104 such as the Internet.

The merchant is then prompted by the payment application in the merchant's device 102 to enter purchase information and payment card information 202. The merchant will swipe the payment card 101,202 in the card reader and thereby reading payment card information from the magnetic stripe on the payment card into the merchant's device. The merchant will also manually or automatically enter purchase information in the merchant's device. The entered purchase information generally comprise the amount that the cardholder is paying for the item or service, but may also comprise further information about the item (such as a description of the item or service), information about the merchant (such as social security number, etc.), the merchant's business (such as the merchants bank account number, VAT identification number or the like), the geographical position of the merchant's store or the merchant's device.

The magnetic stripe on the payment card usually contain up to three tracks with payment card information written in different encodings. The read payment card information generally comprises a primary account number (PAN), the name of the cardholder and but may also comprise discretionary data. The discretionary data may differ depending on the type of payment card and may be any of a personal identification number (PIN) verification value (PVV), expiry date and a card security code (CSC, also known as CVC, CVV, CVV2, CVD, etc.).

The PAN is a structured and standardised numbering scheme in accordance with ISO/IEC 7812. The ISO/IEC 7812 number is typically 16 digits in length and it consists of:
a six-digit Issuer Identification Number (IIN), the first digit of which is the Major Industry Identifier (MII),
a variable length (up to 12 digits) individual account identifier,
a single check digit calculated using the Luhn algorithm.

The PAN is often embossed or printed on the payment card and encoded the magnetic stripe in accordance with ISO/IEC 7810 and ISO/IEC 7811.

The entered purchase information and read payment card information are transmitted from the merchant's device 103 to a payment server 105, in encrypted form, for instance using an industrial strength Secure Socket Layer (SSL) encryption method, via a wireless or wired link over a network such as the Internet 104, step 203.

When the payment server 105 receives the purchase information and the payment card information, the payment server initiates a payment session 204 and decrypts the received purchase information and payment card information. The received purchase information and payment card information may temporary be stored in the payment server 105 for the duration of the payment session. The payment server 105 will serve as the hub for the on-going payment session, managing the payment session with the merchant's device 102, the bank server 106 and the cardholder's device 103 to complete or reject the payment. The payment can be rejected for several reasons such as that the cardholder has not got enough money on his or hers bank account, any step in the payment session goes wrong, the cardholder or the merchant are band due to misuse of the payment service or due to criminal matters, etc.

The payment session may or may not be limited in time. If the payment session is limited in time, a time-limited payment session is started in the payment server 204. If the payment session is limited in time, all information relating to the ongoing payment session will be deleted for security reasons if the payment session times-out, despite being managed in a secure environment in the payment server 105. A time-out receipt stating that the merchant and the cardholder engaged in a payment that timed-out may optionally be stored in the payment server 105.

In step 205, the payment server 105 compares all or a part of the received and decrypted payment card information with previously stored payment card information in the payment server 105. Each payment card information stored in the payment server 105 is associated with list of contact information compiled by the cardholder (usually during a registration process). The list of contact information comprises at least one way of how the cardholder associated to the payment card from which the payment card information is extracted, can be reached or contacted. The contact information may for instance comprise (at least) one or several of; a phone number, an email address, a Skype identity, Google Talk identity, or any other type of communication address. If the comparison of the received payment card information and the stored payment card information results in a match, the associated list of contact information associated with the matched stored payment card information can be retrieved from the payment server 105. Payment card information and the associated list of contact information may for instance be stored in the payment server 105 during a mandatory registration process that the cardholder has to complete before the cardholder can use the payment card 101 for the first time.

If the comparison results in a match, the retrieved list of contact information (comprising for instance a phone number and an email address) is, in an embodiment of the present invention, transmitted from the payment server 105 to the merchant's mobile device 103. When the merchant receives the list of contact information in the merchant's device 102, the list of contact information (for example the phone number and the email address) is displayed to the merchant. The merchant is then able to select one of the displayed, in the payment application in the merchant's device, contact information from the list of contact information, for example the phone number, preferably in cooperation with the cardholder.

In step 206, the selected contact information is transmitted back to the to the payment server 105 via the payment application in the merchant's device 102. The transmission over the network 104 between the merchant's device and the payment server 105 may or may not be encrypted using SSL technique.

In step 207, a request for PIN message is transmitted to the cardholder's device using the selected contact information. The request for PIN message is displayed in a payment application on a display in the cardholder's device (103). In an embodiment of the present invention, the request for PIN message contains a web address, such as a uniform resource locator (URL), to a secure web page. The request for PIN message containing the URL is displayed to the cardholder in a payment application on a display in the cardholder's device, and the cardholder activates the web address by for instance clicking on it. A secure web page is then accessed on the payment server 105 and securely displayed to the cardholder in the payment application in the cardholder's mobile device. The previously entered (by the merchant) PIN is presented to the cardholder using the secure web page. The web page may in a variant also contain information about the merchant (i.e. personal name, name of the store, VAT identification number, geographical position, etc.) and the amount to be charged. In step 208, at the secure web page the cardholder is prompted to submit the PIN in order to continue the payment session and the time-limited payment session if one has been started. The secure web page is preferably hosted on the payment server 105 in a secure, both physically secure and software secure way, environment. The entering of the PIN may then, computer wise, take place in the secure environment on the payment server 105 in an encrypted state and not in the unsecure environment in the cardholder's device 208, and thus eliminating any eavesdropping applications running in the cardholder's device. The cardholder enters the PIN in the secure web page, and thereby submitting the PIN from the cardholder's device 103 to the payment server 105.

In a variant, the payment application could be a compiled application launched in the cardholder's otherwise unsecure cardholder's device 103. The payment application in the cardholder's mobile device establishes a secure and encrypted connection with the payment server 105using industry-standard-strong-SSL technique. After establishing a secure and encrypted connection the payment application creates a secure environment in the mobile phone by for example using a web-based sandbox technique. In this way the card holder may safely enter his or hers PIN code without the risk of a malicious third party program intercepting it. The actual representation of numbers and/or letters in the payment application could be uniquely created for the occasion by the payment server and will not be re-used. Even if the communication between the payment application in the cardholder's device 103 and the payment server 105 is intercepted and decrypted, the numbers and/or letters are only meaningful when combined with a secure key in the payment server 105, and thereby making the entering of the PIN code very safe and secure.

In another embodiment of the present invention the payment server 105 may also verify that the PIN code submitted via the cardholder's device is legit and that the payment session initiated by the merchant is legit by for instance comparing the geographical positions of the merchant's device 102 and the cardholder's device 103. This approach requires that both the merchant's device 102 and the cardholder's device 103 transmit their geographical location (by for instance reading the global positioning system (GPS) coordinates from a GPS service in each device) to the payment server 105 for comparison. The merchant's device's coordinates may either be pre-registered in the payment server 105 (a store usually do not change location that often) or it may be included in the purchase information or in the payment information transmitted to the payment server 105. The cardholder's device 103 may for instance submit its geographical coordinates when submitting the PIN code to the payment server 105. If the payment server 105 comes to the conclusion, by comparing the geographical coordinates with each other, that the merchant's device and the cardholder's device are separated more than a specified distance from each other, then the card payment session may be terminated and an error or rejection message may be sent to the merchant's device and/or to the cardholder's device.

In the payment server 105, the payment card information in the payment server 105 is updated with the received PIN code, thus forming an updated payment card information.

The payment server 105 will transmit the updated payment card information (with the PIN) and the purchase information to the bank server 106,209 for conducting the electronic card payment between the merchant and the cardholder. The bank server will, when conducting the electronic card payment perform an on-line verification and a payment transaction (i.e. a disbursement of money from the cardholder's account to the merchant's account). The transmission between the payment server 105 and the bank server 106 may be encrypted with a method that fulfills the requirements of worldwide standards of security of online transfer of payment card details through a secure socket layer.

The bank server 106 receives the encrypted purchase information and the updated payment card information, decrypts the encrypted purchase information and the updated payment card information, verifies the updated payment card information and performs the payment transaction if everything checks out. The bank server 106 completes the on-line verification and payment transaction by transmitting a receipt message from the bank server 106, to the payment server 105. The receipt message may for instance contain an acknowledgement whether the payment amount was successfully charged to the account or not.

The receipt message is transmitted from the payment server 105 to the merchant's device 102, and displayed to the merchant in the payment application on the display, and/or to the cardholder's device, and displayed to the cardholder in the payment application on the display. The receipt message is stored in the payment server 105. Since the receipt message is stored in the payment server 105 it may later be accessed and viewed by the merchant and/or the cardholder. The transmitting and storing of the receipt message formally ends the payment session or the time-limited payment session if one has been started.

In a variant, the receipt message together with a signature request is transmitted from the payment server 105,210 to the merchant's device 102 and displayed to the merchant in the payment application on the display. The merchant hands the merchant's device 102 to the cardholder whom enter his or hers signature in the payment application, and thus signing the receipt message 211. The cardholder enters his or hers signature using the touch screen and a stylus, or any other method, to enter the signature on the merchant's device 102. The signed receipt message is transmitted in an encrypted state to the payment server 105,211 from the merchant's device, where a payment receipt is generated based on said signed receipt message. The payment receipt is stored in the payment server 105. The generation of the payment receipt in the payment server 105 formally ends the payment session or the time-limited payment session if one has been started. The payment receipt may be transmitted to the merchant's device 102, to the cardholder's device or to both the merchant's device 102 and to the cardholder's device. Since the payment receipt is stored in the payment server 105 it may later be accessed and viewed by the merchant and/or the cardholder.

If any of the steps in the payment session mentioned in above description generates an error, is denied or faulty, an error message is generated and transmitted to the merchant's device 102 and/or the cardholder's device.

In this way a payment session may be completed without the need for a payment card 101 with an EMV-approved chip, a fully secure merchant's device 102, a fully secure cardholder's device 103 or a secure card reader.

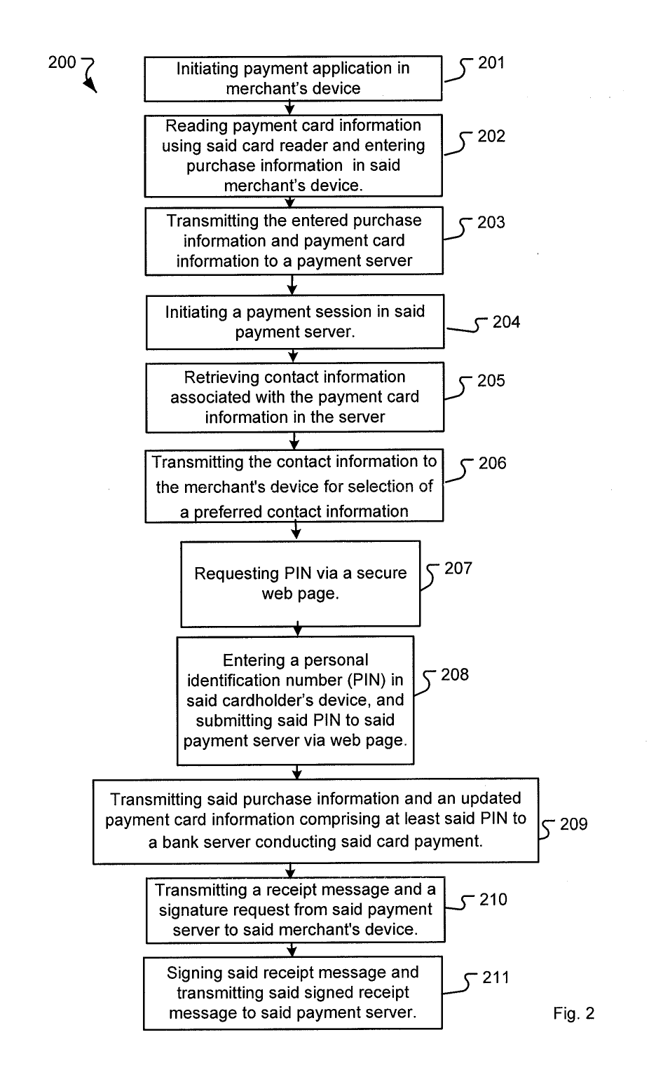

It is to be understood that as stated above this is a typical use-case. However one or more of the steps disclosed in FIG. 2 may be omitted. For example could steps 209 and 210 be omitted.

By requesting a PIN code from the cardholder instead of entering it in the merchant's device an improved level of security is achieved. In this way the cardholder always have to be an active part of the payment sessions and the card information and the PIN code is never in, or passing through, the same device which dramatically improves the security of the payment session. The only other part in the payment session, except for the cardholder, that has access to both the payment card information and the PIN code is the payment server 105. The payment server 105 is easy to keep safe, both physically and software-wise since it is usually placed in a remote secure location and protected by state-of-the-art security software.

Furthermore, the payment method comprising the combination of using a user signature in the merchant's device and the method of requesting a PIN code from the cardholder's device, will increase the security further, because this solution requires proximity (i.e. being in the same physical location) between the merchant's device and the cardholder's device since the cardholder is required sign the receipt message in the merchant's device.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

The foregoing has described the principles, preferred embodiments and modes of operation of the present invention. However, the invention should be regarded as illustrative rather than restrictive, and not as being limited to the particular embodiments discussed above. The different features of the various embodiments of the invention can be combined in other combinations than those explicitly described. It should therefore be appreciated that variations may be made in those embodiments by those skilled in the art without departing from the scope of the present invention as defined by the following claims.

1. A method of conducting an electronic card payment between a merchant, having a merchant's device with a card reader, and a cardholder, having a payment card and a cardholder's device, comprising:
reading payment card information associated with said payment card using said card reader in said merchant's device;
entering purchase information in the merchant's device and transmitting said purchase information and said payment card information to a payment server;
entering a personal identification number (PIN) in said cardholder's device, and submitting said PIN to said payment server; and
transmitting said purchase information and an updated payment card information comprising at least said PIN to a bank server conducting said card payment.

2. The method according to claim 1, further comprising:
in said payment sever retrieving, from previously stored payment card information, at least one contact information associated with said received payment card information; and
transmitting a request for PIN message to said cardholder's device, using said contact information.

3. The method according to claim 2, wherein said request for PIN message contains a web address of a secure web page on said payment server and wherein the step of submitting the PIN comprises submitting said PIN via said web page.

4. The method according to claim 2, wherein the contact information is at least one phone number or one email address.

5. The method according to claim 1 further comprising:
transmitting said at least one contact information associated with said payment card to said merchant's device; and
selecting in said merchant's device a contact information to use for communication with said cardholder's device and transmitting information about said selection to said payment server, and
wherein said request for PIN message is transmitted to said cardholder's device, using said selected contact information.

6. The method according to claim 1 further comprising:
transmitting a receipt message and a signature request from said payment server to said merchant's device; and
signing said receipt message and transmitting said signed receipt message to said payment server.

7. The method according to claim 1, further comprising:
determining, in the merchant's device, the geographical coordinates of the merchant's device, and transmitting it to said payment server;
determining, in the cardholder's device, the geographical coordinates of the cardholder's device, and submitting it to said payment server;
in the payment server comparing the geographical coordinates of the merchant's device and the cardholder's device, and if said geographical coordinates are separated more than a specified distance from each other an rejection message is transmitted from said payment server to said merchant's device and/or to the cardholder's device.

8. The method according to claim 1 further comprising the step of:
starting a time-limited payment session in the payment server when said purchase information and payment card information is received from said merchant's device.

9. A system for conducting an electronic card payment between a merchant and a cardholder, the system comprising
a merchant's device;
a cardholder's device;
a payment server;
wherein said merchant's device, cardholder's device, payment server, and bank serve are adapted to perform the steps described in claim 1.

10. A system according to claim 9, wherein the system further comprises a bank server.
